(19) United States
(12) Patent Application Publication
(10) Pub. No.: US 2020/0143468 A1
(43) Pub. Date: May 7, 2020

(54) SYSTEM FOR FINANCIAL INFORMATION REPORTING

(71) Applicant: CRONUS CONSULTING GROUP PTY LTD, Sydney (AU)

(72) Inventor: Steven James RILEY, Sydney (AU)

(21) Appl. No.: 15/751,235

(22) PCT Filed: Aug. 15, 2016
(86) PCT No.: PCT/AU2016/000281

§ 371 Date: Feb. 8, 2018

(30) Foreign Application Priority Data
Aug. 13, 2015 (AU) 2015903252

(51) Int. Cl. G06Q 40/04; G06Q 40/06; G06F 40/56; G06F 40/242

(52) U.S. Cl. CPC G06Q 40/04; G06Q 40/06; G06Q 2220/00; G06F 40/242; G06F 40/56

(57) ABSTRACT

A system for generating a financial report in a reporting currency, comprising: at least one database; the database comprising a first source dataset associated with a first segment of an organisation and at least a second source dataset associated with a second segment of an organisation; the first and second source datasets associated with at least one source currency which is the same or different between the first source dataset, the second source dataset and the reporting currency; and a foreign currency exchange rate dataset relevant to the source and reporting currencies, wherein the system manipulates, augments and/or converts the first source dataset and the second source dataset, uses at least one foreign exchange rate extracted from the foreign currency exchange rate dataset and converts the financial information of the source datasets by the at least one foreign exchange rate to the reporting currency for generating the financial report.

### TECHNICAL FIELD

The present invention relates to a system and method for generating a financial report. More particularly, the present invention relates to a data processing system which may merge or replicate data sets from financial and non-financial systems for generating a financial report.

### BACKGROUND

With the increasing globalization of the world economy, there is an increasing number of businesses that have commercial operations in different geographical regions and must adopt differing financial and non-financial systems. These systems may be based on regulatory, organisation, or other industry compliance requirements or preferences, such as a particular accounting standard or best practice standard. For example, compliance with IFRS (International Financial Reporting Standards) may be adopted in one region and compliance with GAAP (Generally Accepted Accounting Principles) may be adopted in another region. In another example, a particular currency, such as Australian Dollars (AUD), Euros (EUR), United States dollars (USD), Japanese Yen (JPY), Chinese Yuan (CNY), may be required to appear on organisation reports in some jurisdictions, while a different currency may be required to appear on organisation reports.

Furthermore, complications may arise when accounting software or other systems are upgraded or modified. Upgrading or modifying systems may increase the risk of backwards incompatibility issues or, for example, formatting incompatibility. In addition, different business segments/divisions of the same business may use different software to one another, because, for example, some business segments/divisions have certain restrictions as to the software that is available to them, or because software that suits one or some business segments/divisions does not suit the specific needs of other business segments/divisions. This may cause problems with reporting across segments or divisions of a business. For example, an organisation may have a real estate segment and a building construction segment, with each such segment required to issues different reporting formats.

With respect to non-financial systems, problems may arise where one subsidiary organisation or segment uses one payroll system, and another subsidiary organisation or segment uses a different payroll system. Further problems may arise where one subsidiary or division adopts an ERP (Enterprise Resource Planning) system for business management and produces management accounts, but the local laws require that subsidiary or division to provide a set of statutory accounts.

In view of the rapid globalisation of organisations and the number of different segments and divisions within the same businesses, a number of reporting systems have been developed to assist organisations in reporting between segments. However, these systems must be reformatted or augmented and similar data sets must be matched to a pro-forma report which is a time consuming process and may require multiple systems to generate a report. It also requires a not insignificant amount of human and technology resourcing which can be costly.

To address these issues, a number of organisations, and, in several cases, their business segments/divisions/subsidiaries have attempted to develop and maintain in-house systems, using financial and non-financial software, personalised for those respective organisations or business segments/divisions/subsidiaries. That approach results in a wide range of data sets being produced by organisations which may result in conflicting or skewed data when comparing similar organisations to one another and/or when attempting to normalize results between business segments/divisions/subsidiaries within the same organisation. Further, new software or product patches may cause data sets to become incompatible with older versions which may also produce further difficulties for compiling commercially useful and regulatory compliant reports.

As such, some of the previous attempts to overcome the aforesaid difficulties have been focusing on integration of, and harmonising, report data to compile an overarching report that reflects ‘common data’. However, even then, there are a number of difficulties in forming a report based on financial and non-financial data, not to mention further difficulties in providing a report that spans multiple jurisdictions (each with their own local reporting compliances) and/or different business segments/divisions/subsidiaries.

There have been a number of systems which have been created by organisations so that they can generate reports across business segments/divisions/subsidiaries. These systems may include: multiple financial and non-financial record keeping mechanisms that are unrelated, utilising multiple currencies and single data sets concerning foreign exchange rates, adopting complex organisational structures, having multiple entities, pursuing unrelated business lines, consolidating assets that may be physical, adopting technical (in the sense of interfaces and data conversion requirements) or financial timeliness to bring together information, and so on and so forth.

Other analytic, diagnostic and reporting systems have also been used to harmonise data. However, these systems make overall report generation more complex and increase the number of steps to achieve a final report. Some problems with these current systems may include: slow access to information and long processing times, human processing errors involved in preparing reports, the need for technical skill of the user in knowing how to use the system and/or particular commands to access relevant information in undertaking analytic and diagnostic functions and compiling reports, difficulty in restricting user access to sensitive information without displaying the information to the user or limiting the ability to extract information that may be necessary for particular analytic, diagnostic and reporting function that the user should be able to perform, the expense of such systems and consequently the restricted usage of same, security sensitivities given the nature and volume of information accessible to users, the propensity to use menu driven systems, making finding and running reports to be a complicated process, limited ability for users to customise their reports in terms of rounding, formatting and currency settings at the time of running the reports, the ability to consolidate unrelated structured data into a single result, and so on and so forth.

Known reporting systems commonly use a single foreign exchange (FX) rate when generating a report which typically may not produce a consistent method for reporting in differing currencies. This is partially due to the restrictions associated with traditional reporting methods as current systems may only consider independent sets of reporting data which may have been previously altered by an organisation/business segment/division/subsidiary. Further, traditional reporting systems may have a number of FX rates applied to convert financial and non-financial data which may produce reports with significant amounts of unaccounted revenue or assets due to market volatility. As such, it may be an advantage to generate a report with a more accurate FX conversion.

Further, current reporting systems may take a significant amount of time, particularly with the need to allow sufficient time to process, review, convert and consolidate information The time taken to generate commercially useful and regulatory compliant reports may extend into days or weeks as organisations must sort through and identify relevant data sets between organisations that may be harmonised. In addition, further delays may arise when there are conflicts between reporting requirements, currency conversions or account record requirements.

There is a need for a system that alleviates, ameliorates or otherwise addresses at least some of the current problems of financial reporting faced by existing systems.

Any reference to or discussion of any document, act or item of knowledge in this specification is included solely for the purpose of providing a context for the present invention. It is not suggested or represented that any of these matters or any combination thereof, formed at the priority date, part of the common general knowledge, or was known to be relevant to attempt to solve any problem with which this specification is concerned.

### SUMMARY OF THE INVENTION

According to a first aspect, the present invention provides a system for generating a financial report reflecting a financial information in a reporting currency, the system comprising:

a storage medium with at least one database;

the at least one database comprising a first source data set associated with a first segment of an organisation and at least a second source data set associated with a second segment of an organisation;

the first source data set representing a first financial value relevant to the financial information and the at least a second source data set representing at least a second financial value relevant to the financial information, each financial value having at least one associated source currency which is the same or different as between the first financial value, the second financial value and the reporting currency; and

a foreign currency exchange rate data set, or access to a foreign currency exchange rate data set, that has foreign currency data relevant to at least the source currency for each of the first financial value and the at least a second financial value and to the reporting currency,

wherein the system manipulates, augments and/or converts the first source data set and the at least a second source data set to determine the financial information, and uses at least one foreign exchange rate from a set of foreign exchange rates extracted from the foreign currency exchange rate data set and converts the financial information by the at least one foreign exchange rate to the reporting currency for generating the financial report.

In a preferred embodiment, the financial report is generated in real-time.

Preferably, the average foreign exchange rate is calculated for a predetermined time. In some preferred embodiments, the predetermined time is separated into a plurality of discrete time intervals such that multiple average foreign exchange rates are calculated over the predetermined time for converting the source currency. Preferably, the foreign currency exchange rate data set includes one or more of the following foreign exchange rates: an opening exchange rate, being the exchange rate at which the discrete time interval began, a closing exchange rate, being the exchange rate at which the discrete time interval closed, and an average exchange rate, being an average of the exchange rates throughout the discrete time interval.

In some preferred embodiments, the at least one database includes a first stage mapping database and a second stage mapping database. Preferably, the manipulation, augmentation and/or conversion of the first source data set and the second source data set is carried out in association with at least one of the first source data set and the at least second source data set being mapped by a first stage mapping process and assigned to the first stage mapping database and stored as first stage mapping data. In yet still further preferred embodiments, the first stage mapping data is further mapped by a second stage mapping process and assigned to the second stage mapping database and stored as mapped source data. Some embodiments provide that at least one cryptographic function is applied to the mapped source data.

Preferably, the report is generated in an alternate language selected from the at least one database.

In particularly preferred embodiments, the system is adapted to generate the report taking account of different financial year regimes applying to different source data sets. Preferably, the system adjusts the different financial year regime data so as to provide consolidated financial information. Yet still further preferred embodiments provide that the system is adapted to automatically determine a currency and a language to generate a report.

Preferably, executing a runtime code generates the report.

In some preferred embodiments, the generated report is stored by the system.

In some preferred embodiments, a report is displayed to different users in different languages.

The second segment of an organisation is another entity in some preferred embodiments.

According to another aspect, the present invention provides a system for generating a financial report, the system comprising:

a storage medium with an associated database;

the associated database comprising a plurality of data sets associated with at least one organisation;

the plurality of data sets including at least one source currency data set associated therewith; and

wherein the system calculates an average foreign exchange rate, with respect to at least one opening foreign exchange rate and at least one corresponding closing exchange rate, such that source currency data set can be converted by the average foreign exchange rate to represent a respective foreign currency for generating the report in real-time.

In a further aspect, the present invention provides a system for generating a report, the system comprising;

a storage medium with an associated database, the database stores a plurality of data sets;

the plurality of data sets comprising at least one currency and at least one language; and

wherein when a user selects a predetermined output language and a predetermined output currency, the system executes a runtime that generates an output report in real-time, in which the at least one currency is output in the predetermined output currency and the at least one language is output in the predetermined language.

Preferably, the system displays an output report to a second user via a user display device in at least one of the group consisting of: the at least one language; the output language; the at least one currency; and the output currency.

In preferred embodiments of the invention according to this and other aspects, the system comprises at least one database selected from a mapping database and a dictionary database. Preferably, the dictionary database is used to generate a report in a predetermined language.

Another aspect of the present invention may relate to a system for generating a report. The system comprising a storage medium with at least one database. The at least one database comprising a first source data set associated with a first segment of an organisation and a second source data set associated with a second segment of the organisation. At least one of the first source data set or the second source data set having at least one source currency data set associated therewith and wherein the system calculates an average foreign exchange rate based on at least one set of rates, such that source currency data set can be converted by the average foreign exchange rate to represent a respective foreign currency for generating a report in real-time.

Preferably, the average foreign exchange rate is calculated for a predetermined time. Preferably, the predetermined time is separated into a plurality of discrete time intervals such that multiple average foreign exchange rates are calculated over the predetermined time for converting the source currency.

Preferably, the multiple average foreign exchange rates are averaged such that the average of the multiple average foreign exchange rates is used to at least one of: convert the source currency and used to produce a reporting currency.

Preferably, the at least one data base includes a first stage mapping database and a second stage mapping database. Preferably, at least one of the first source data set and the second source data set is mapped by a first stage mapping process and assigned to the first stage mapping database and stored as first stage mapping data.

Preferably, the first stage mapping data is mapped by a second stage mapping process and assigned to the second stage mapping database and stored as mapped source data. Preferably, at least one cryptographic function is applied to the mapped source data.

Preferably, the report is generated in an alternate language selected from the at least one database. Preferably, multiple financial years can be converted by the system.

Preferably, the system can automatically determine a currency and a language to generate a report. Preferably, executing a runtime code generates the report. Preferably, the generated report is stored by the system. Preferably, a report can be displayed to multiple users in at least one different language. Preferably, the second segment of the organisation is a second organisation.

Another aspect of the present invention may relate to a system for generating a report, the system comprising; a storage medium with an associated database. The associated database comprising a plurality of data sets associated with at least one organisation. The plurality of data sets including at least one source currency data set associated therewith; and wherein the system calculates an average foreign exchange rate, with respect to at least one opening foreign exchange rate and at least one corresponding closing exchange rate, such that source currency data set can be converted by the average foreign exchange rate to represent a respective foreign currency for generating a report in real-time.

A further aspect of the present invention may relate to a system for generating a report, the system comprising; a storage medium with an associated database. The database stores a plurality of data sets. The plurality of data sets comprising at least one currency and at least one language, and wherein a user selects a predetermined output language and a predetermined output currency. The system may then execute a runtime which generates an output report in real-time, in which the at least one currency is output in the predetermined output currency and the at least one language is output in the predetermined language.

Preferably, the system is adapted to display an output report to a second user via a user display device in at least one of the group of; the at least one language, the output language, the at least one currency and the output currency. Preferably, the system further comprises at least one database selected from. a mapping database and a dictionary database. Preferably, the dictionary database is used to generate a report in a predetermined language.

### BRIEF DESCRIPTION OF THE FIGURES

FIG. 1 illustrates an overview of the data processing system according to one embodiment of the present invention, involving use of a cloud server;

FIG. 2 illustrates a flow chart of the system in which source data from more than one source system is used to generate a financial report according to one embodiment of the invention;

FIG. 3 illustrates a flow chart of the system in which source data is mapped in a first stage and a second stage mapping process according to one embodiment of the invention;

FIG. 4 illustrates another embodiment of the hardware components of one embodiment of the present invention;

FIG. 5 illustrates a side-by-side comparison of a process flowchart of a currently used method of report generation relative to a system according to one embodiment of the present invention for generating a report;

FIG. 6 illustrates the flowcharts of FIG. 5, with the addition of an improved executable runtime process for generating a report according to one embodiment of the invention;

FIG. 7 illustrates a flowchart overview of the improved executable runtime process of the embodiment depicted in FIG. 6;

FIG. 8 illustrates a hierarchy that typically governs the report generation process according to one embodiment of the invention; and

FIG. 9 illustrates one embodiment of a user interface with filters and options adapted to facilitate report generation by one embodiment of the system of the invention.

### DETAILED DESCRIPTION OF PREFERRED EMBODIMENTS THE INVENTION

Preferred embodiments of the invention will now be described with reference to the accompanying drawings and non-limiting examples.

One preferred embodiment is directed towards a process or system for generating a financial report based on data from at least a first data source and a second data source. One or more data sources may be used by the system. The first data source may be related to a first organisation and the second data source may be related to a second organisation. These data sets may be derived from financial and non-financial systems of an organisation, which themselves may be associated with operational practices, operational requirements or statutory requirements. Operational requirements and/or practices may include internal reporting requirements (and analysis and/or diagnostics of non-financial and/or financial data) and/or regulatory specification as determined by statutory and non-statutory reporting requirements, and/or by particular customised ERP systems such as SAP™ or ORACLE™ designed specifically for a particular service or manufacturing sector.

Preferred embodiments of the present invention provide a data processing system for generating a financial report, wherein the system obtains data from multiple jurisdictions and/or with different currencies. In preferred embodiments, the system is adapted to generate a report for multiple segments/divisions/subsidiaries of an organisation which may be located across multiple jurisdictions or may use different currencies. However, it will be appreciated that a financial report may also be generated for a single organisation with a single jurisdiction and single currency.

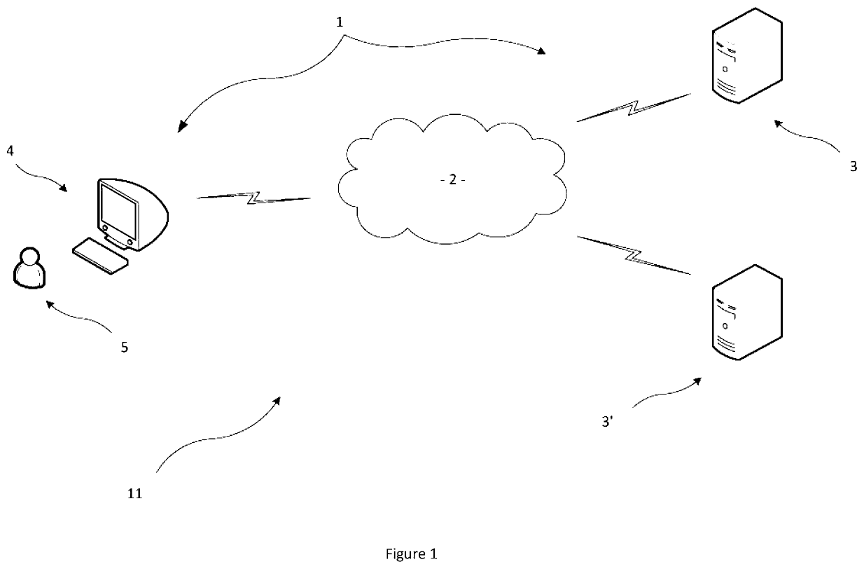

Referring to FIG. 1, the system 11 preferably comprises a client/server arrangement 1 such that a user 5 of a client 4 may generate a financial report. The term ‘client’ may be a computer, a laptop, a tablet, a mobile phone or any other suitable electronic device. Preferably the system allows a user to communicate with a first device 3, and optionally at least one further device 3′. The first device 3, and optionally the at least one further device 3′, may be connected to the internet or be in a network configuration with the client 4. A server 2, which may be a cloud or physical server, may host or store a portion of the data which the system 11 may access. Preferably, the server 2 may be hosted remotely with respect to the client 5 and the server may be adapted to communicate with a number of clients at any one time which may be located in more than one geographical location or jurisdiction.

In one embodiment, the system 11 may generate a financial report by:
a. Allowing a user 5 to establish any mapping rules or other business or predetermined rules which may assign, modify or augment raw data uploaded to the system. Assigning, modifying or augmenting data may allow a characterising feature to be assigned to a set of data, such as a time stamp, a business name or any other desired data marker which may then be stored by the system;
b. A user 5 of the system 11 may cause the client 4 to execute a runtime code such that the at least a portion of uploaded data may be used to update data previously uploaded or associated with the system 11. This data may have a number of real-time conversions applied or data may be calculated using predetermined equations such that financial and non-financial data is generated to report to a user 5 of the system 11. Alternatively or in addition, the system 11 may identify data gaps or may provide an analysis of the data to a user 5; and
c. The system 11 may generate an output, preferably in the form of a report, and/or to allow a hierarchy report to be generated and level report to be issued.

A hierarchy report may include all data, for review by predetermined management personnel of an organisation. Reports generated to or for other personnel, such as, managers, employees or any other level within an organisation may contain a lower level, censored, or redacted report.

The system preferably has a first data mapping stage or first stage mapping which may be adapted to map selected source data and assign or store it in a first database structure. Mapping data may be manipulated, or be assigned dictionary terms, or have at least one rule applied to it which allows data to be assigned attributes such that the system may more correctly and accurately assign data for generating a report. The attributes may be in terms of operational requirements or, for example, statutory requirements that may be determined by a financial or non-financial body. The attributes may be determined by reference to a system, a chart of accounts, a business entity, a cost/profit/investment centre, and/or a project/job/driver for financial or non-financial markets.

A second stage mapping may also be applied by the system to the data mapped by the first stage mapping process. The second stage mapping may also have reference to a dictionary or at least one predetermined rule. More particularly, the second stage mapping maps the first stage mapped data in the first database structure to a second database structure, and is stored as mapped source data, which may be assigned predetermined field dictionaries. It will be appreciated that the first and second database structures may be contained within the same storage device or medium and/or may be segregated.

The dictionary or rules may characterise the second stage mapped data in terms of management levels as determined by a predetermined set of rules or factors, which may include at least one of: economic and reporting groups; divisions within one or more of the groups; geographic constraints and boundaries for reporting purposes; business entities; cost centres within one or more of the groups; project numbers within one or more of the groups; and account numbers for charts of account and account balances. It will be appreciated that a user of the system may upload rules to the system to further augment or modify source data during the first stage or second stage mapping processes. A stage mapping process may be referred to throughout the specification as a “stage mapping”.

Management levels may be derived from the first stage and/or second stage mapped data, and the management requirements of the organisation may be ascertained in accordance with the information required to manage different parts or aspects of the organisation. This information may be independent of, but may overlap with, the level of the operational requirements of the organisation.

Source data from the financial and non-financial systems of an organisation may characterise the organisation and the business. The source data may define the organisation in terms of its operational requirements or operational practices. The source data may be obtained from at least one of the group of: data extracted from a system or application (e.g. Microsoft Excel™) internal reports or regulatory reporting requirements; analysis and/or diagnostics of financial and non-financial data, including that obtained from a regulatory body which is statutorily associated with the organisation; statutory or non-statutory reporting requirements; and requirements that have been developed or preferred organisation practices. It will be appreciated that the data may be electronic or manual.

In one example, some source data may be determined with respect to IFRS or GAAP accounting requirements adopted by a country or region where an organisation has a business activity, and/or by particular customized ERP systems, such as SAP™ or ORACLE™, designed specifically for a particular service, manufacturing or other sector.

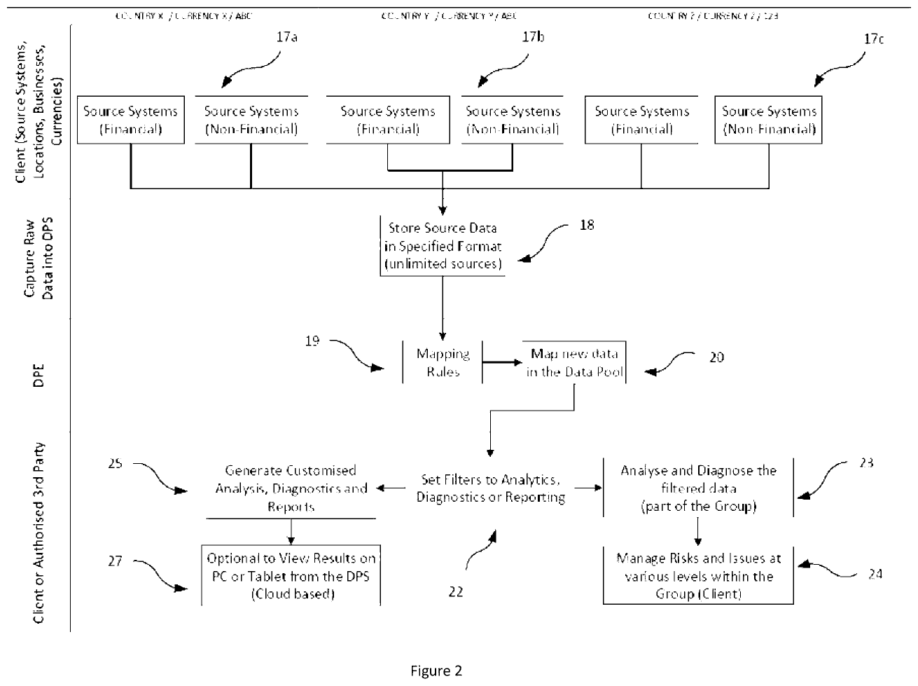

The methodology followed by one embodiment of the system for processing the data by an administrative user is shown in the flowchart of FIG. 2. In this non-limiting example, the organisation, referred to as a client, has business activities in a number of countries, Country X, Country Y and County Z. Each of these countries may have a different respective currency, Currency X, Currency Y and Currency Z. The business activity in Countries X and Y is the same, generally described as ABC in each case. The business activity in Country Z is different from the business activity in Countries X and Y, and is described as “123”.

Each of the business activities of the client in each of the countries is indicated in the top row and each may have its own financial and non-financial source systems 17a, 17b and 17 respectively. The source systems 17a, 17b, 17c, may be associated with a geographical or regional location, a business activity and/or preferred currency (such as, Australian Dollars, Euros, United States Dollars, Yen or Yuan) and may be a financial system or non-financial system. Each of the source systems may comprise different currencies or business drivers underlying the different business activity, historical information and current information.

Source data generated or obtained from the source systems 17a, 17b, 17 may be stored in data store. The data may be stored in a number or variety of formats, which may include, but is not limited to: xml, PDF, Doc, DocX, PPT, TXT, HTML, PTF, xlsx, xls. It will be appreciated that other data formats may be stored by the data store 18. Preferably, the data is stored in a predetermined format or converted into a predetermined format such that the source data may have mapping rules 19 associated therewith which are mapped in a data pool 20 or mapping database or a storage medium accessible by the system. The data mapped to the data pool may be referred to as mapped source data.

Set filters 22 may allow a report to be generated for analytics, diagnostics or reporting, which may be used to illustrate potential improvements to increase the transparency of the segment or the organisation or may provide a detailed breakdown of an organisation. A user of the system 11 may select to generate a customised analysis report or diagnostics report 25 or to analyse or diagnose at least a portion of the filtered data as part of a group 23. If a report is generated 25, the user may have the option to view the report on a display device, such as a computer, tablet or other suitable device 27. The server may record and log each report generated by a user, such that a user may more quickly retrieve a report after being generated. Optionally, a report may also be timestamped and/or locked to reduce the potential for fraudulent reports being generated. If a user selects analyse and diagnose filtered data 23, the output report of the system may allow a user to understand and manage risks and issues associated with levels within a group 24. More particularly, the output report generated may identify levels of an organisation which are making a loss or are underperforming such that an organisation may be more easily able to identify, for example, a restructuring potential.

Preferably, the first stage of mapping assigns at least one predetermined rule or dictionary term to at least part of the source data 28. The first stage mapping may assign organisational information to source data 28. Predetermined rules may refer to management requirements which have been previously generated based by the client or an organisation. As these rules are generally associated with financial and non-financial systems of the client, the information may overlap with the operational requirements of the client. More particularly, source data 28 may be assigned an organisation profile or organisation identification such that the system may easily identify relevant organisation data stored by the system. After the first stage mapping has been processed, the first stage mapped data may be stored in a first mapping database.

A second stage of mapping is performed on the data generated from the first stage of mapping. The second stage of mapping may apply at least one mapping rule to the data generated from the first stage of mapping. The mapping may be detailed according to prescribed groups that may classify or characterise an organisation. A prescribed group may include at least one of: sourced systems; chart of accounts; business entities; cost centres; profit centres; investment centres; asset management; projects; jobs; and drivers. After the second stage mapping has been processed, the second stage mapped data may be stored in the first mapping database, but is preferably stored in a second mapping database as mapped source data.

The source data from the organisations is stored by the system as mapped source data or mapped data. The mapped source data may have reference to both the first stage mapping database and the second stage mapping database, such that it may assess or extract relevant mapping information for generating a report.

In at least one embodiment, the system may be adapted to bypass or skip the first stage mapping or the second stage mapping. A stage of mapping may be bypassed or skipped if no rules or dictionary terms are required to be assigned to a source data set. However, it will be appreciated that this data may also be referred to as mapped source data or mapped data. Optionally, the mapped source data stored by the system may be encrypted at each mapping level in which the first mapping stage makes a hash of the first stage mapped data and the second stage takes a hash of the first stage mapping hash to improve the security of the system. If the data is hashed, a user of the system may be required to retain an encryption key such that the data may only be accessible by predetermined persons or persons with access to the key.

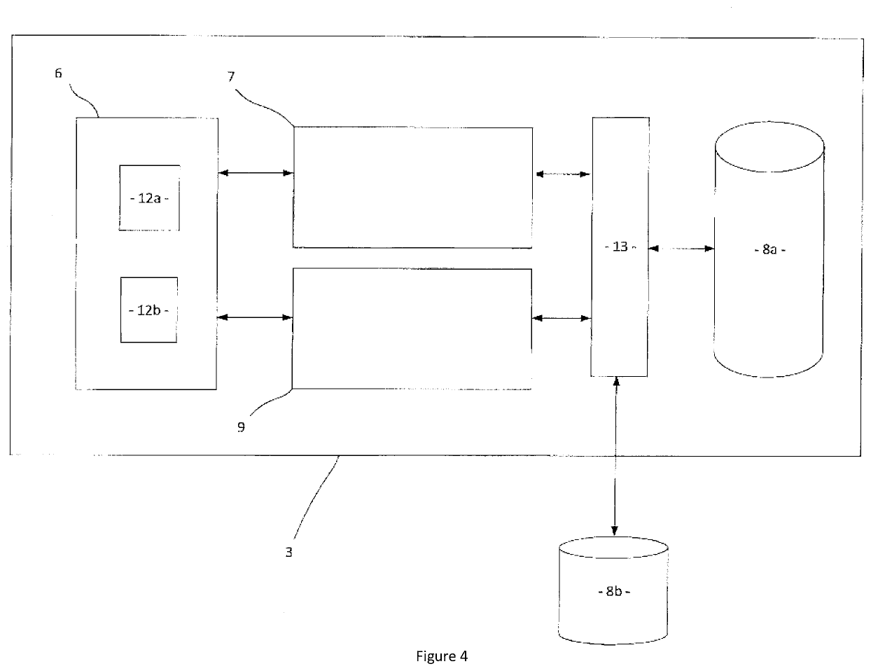

After the system has mapped the data, or has performed a check or confirms that the data does not require mapping, the system may be configured to generate a report. At least one of a third party, a registered user or an authorised person may set at least one filter to the data to undertake a desired analysis, diagnostic, analytics or reporting based on the mapped data. After any filters have been applied, the system analytics and reporting engine 9 assesses, or otherwise analyses and diagnoses, the filtered data (See FIG. 4). This enables the client, authorised person or third party to manage risks and issues at various levels within the particular group of the client as shown at 24.

In yet another embodiment, the reporting and analytics engine, after setting of the filters 22, is selected to generate customised analysis, diagnostics and reports at 25, with the option to view the results on an appropriate display device, such as a personal computer, laptop computer, phone, tablet or other suitable device. Alternatively, the results of the report may be printed on media such as a PC, or tablet from a cloud based setup at 27.

FIG. 4 depicts another embodiment of the system that includes a communication module 6, a data processing engine 7, a data store 8 and an analytics and reporting engine 9. The data store 8 preferably includes a local store 8a serving as a cache, and a remote store 8b. The remote store 8b may be hosted remotely relative to a server 3, but may also be physically associated with the system 11. Data may be retrieved from the remote store 8b for local storage within the local store 8a. The system further comprises a database management system 13, a reporting engine 9, communication module 6, user interfaces 12a and 12b. The user interfaces 12a and 12b allow a user to interact with data stored on the system and/or upload data to the system.

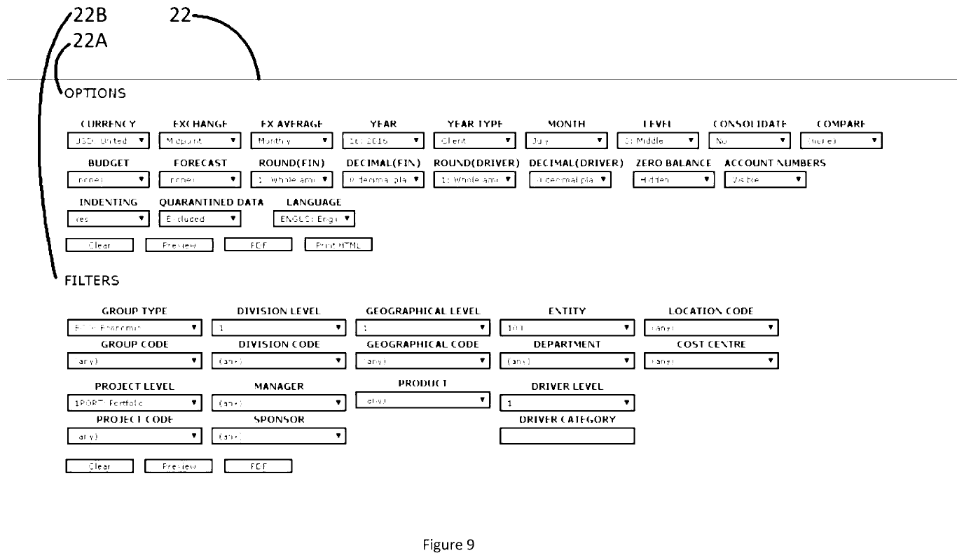

Referring to FIG. 9, there is depicted an embodiment of a user interface which allows a user to set filters 22B and options 22A. As shown, examples of options which may be selected include at least one of: currency: exchange; FX average; year; year type; month; level; consolidate; compare; budget; forecast; rounding option; decimal interval; round (driver); decimal (driver); zero balance; account number; indenting; quarantined data; and language.

A filter can be at least one of: group type; division level; geographical level; entity; location code; project level; manager; product; driver level; group code; division code; geographical code; department; cost centre; project code; sponsor; and driver category.

It will be appreciated that not all options and/or filters are required to be selected by a user. Further, the system may be adapted to automatically fill-in options and/or filters or have options preselected which may reduce the time to generate a report.

Some examples of the analytics and diagnostics which may be performed may include, but are not limited to: forecasting; budgeting; ratio analysis; diagnostic flow charts; risk management; business valuations and Z-Scores. Examples of the reporting that can be performed includes: customised management reporting including historical information; board reporting; compliance reporting; and statutory reporting, in full or part. It will be appreciated that other reporting can also be performed by the system.

A management level may be derived from the mapped data, preferably the second stage mapped data, and the management levels of the organisation may be ascertained in accordance with the information required to manage different parts or aspects of the organisation. This information is independent of, but overlaps with, the specification of the operational requirements of the organisation.

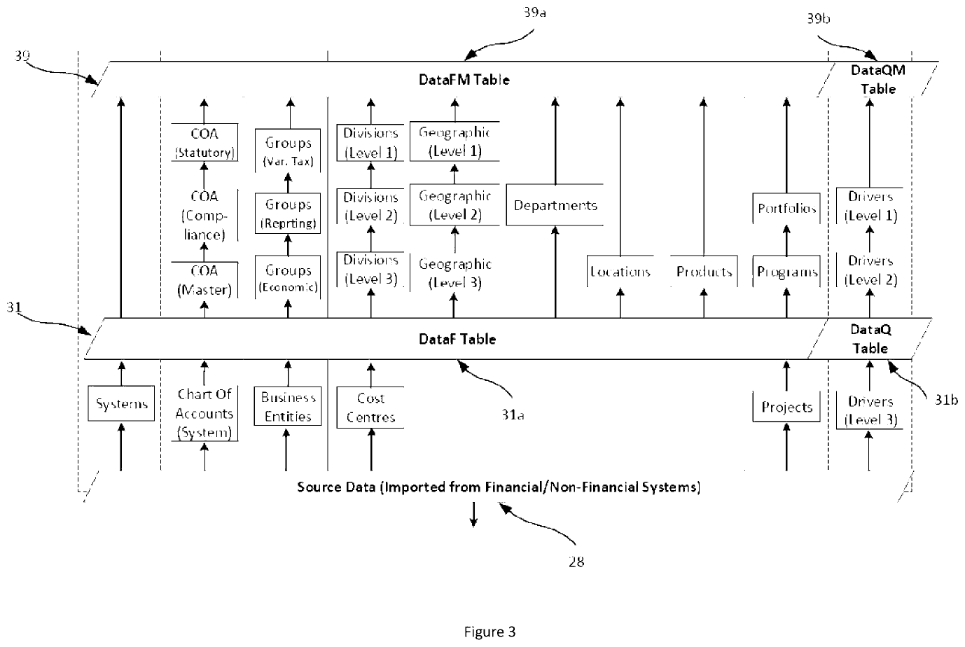

As depicted in FIG. 3, there is provided an overview of the two mapping stages undertaken by the system at the input end of the system. The input end is the point in which source or raw data is extracted from an organisation or uploaded by an organisation. Source data 28 imported from source systems 17a, 17b, 17c is mapped into the first database structure 31, during the first mapping stage using the primary data dictionary detailing the mapped data: (i) in a financial data table 31a according to the prescribed parameters of the financial systems including: Systems, the system Chart of Accounts, Business Entities, Cost/Profit/Investment Centres and Projects/Jobs; and (ii) in a non-financial quantitative data table 31b according to the prescribed parameters of the non-financial systems being the Business Drivers as indicated, and also Systems, Business Entities, Cost Centres and Projects (not shown) in a similar manner to the corresponding financial data table parameters.

For example, a charts of account for organisations X, Y and Z (not shown) may adopt three different Systems, namely System 1, System 2 and System 3, and being based in three different Countries X, Y and Z, respectively. These system charts of account may then be mapped into a master Chart of Accounts.

The source data 28 is preferably stored, either temporarily or permanently, by the system in the form of trial balances obtained from the charts of account, which may be in a prescribed format ready for importing by the data processing engine 7 (see FIG. 4). In at least one embodiment, the data may be converted by the system into the prescribed format.

During the second mapping stage the data values are preferably mapped into the second database structure 39 using the secondary data dictionary detailing the further mapped data: in a financial management data table 39a according to the prescribed groups of the financial systems including: the master chart of Accounts, compliance chart of accounts, statutory chart of accounts, economic groups, reporting groups, various tax groups, different level divisions, different level geographic segments, departments, locations, products and programs and portfolios as indicated; and in a non-financial quantitative management data table 39b according to the prescribed groups of the non-financial systems, being the different level business drivers, as indicated, and also groups, divisions, geographic segments departments, locations, products and programs (not shown) in a similar manner to the corresponding financial data table groups.

Examples of some data sets which may be mapped by the system are illustrated in FIG. 3. It will be appreciated that other data sets may also be mapped and/or stored by the system.

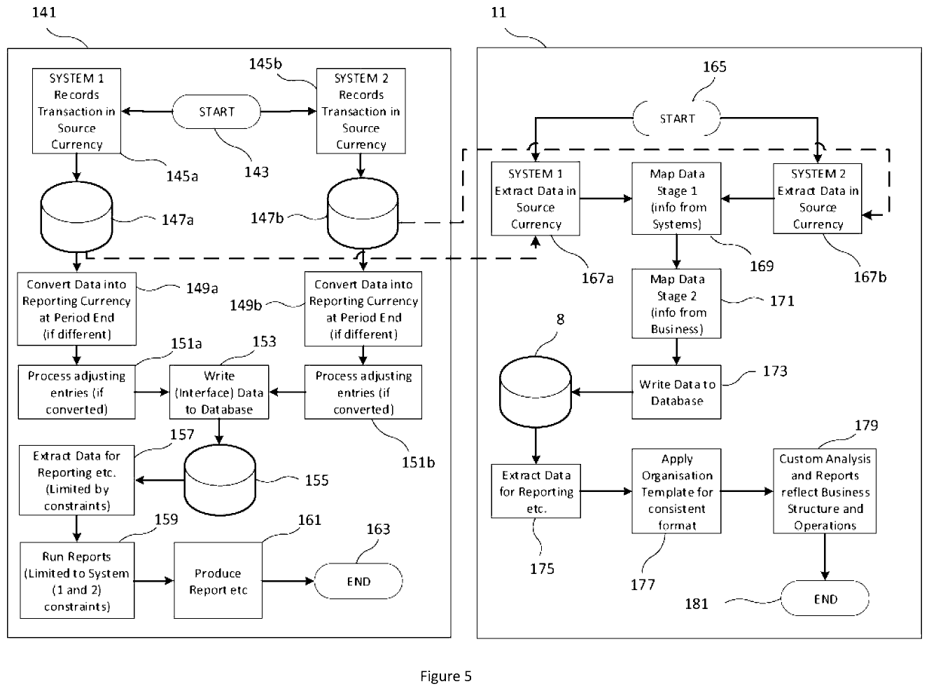

Referring to FIG. 5, there is illustrated an embodiment of the present invention as compared with a prior art transactional processing system. The prior art system 141 starts at 143 with recording transactions of an organisation's financial and non-financial data of its separate business units having different source currencies using their corresponding transactional systems 145a and 145b. The financial and non-financial data is stored as organisational source data within the respective data stores 147a and 147b associated with the particular transactional system 145 of the organisation. As shown, the system 11 of one embodiment of the present invention uses the organisational source data for the inputting of data into the data processing engine 7 of the system 11.

In order to achieve a specified output, the prior art system 141 separately converts the organisational source data stored within each separate data store 147 for each system into the required reporting currency at period end, if different, at 149a and 149b respectively. It then separately processes adjusting entries, if converted, at 151a and 151b, respectively, and writes the data to a database in the reporting currency via an interface at 153 which is stored in a further data store 155. Data may then be extracted at 157 in the reporting currency for reporting, analytics and diagnostics. Modified at 159 are different financial years, if required, before producing the specified output at 161 to end the process at 163.

In contrast, the data processing system 11 of one embodiment of the present invention starts at 165 and extracts raw data from the respective data stores 147a and 147b of the different transactional systems 145a and 145b in the source currency using the data input means of the data processing engine 7. This data may then be mapped at 169 using the first stage mapping means creating the first structured data set of mapped data. The first structured data set of mapped data is subsequently mapped at 171, using the second stage mapping means, thereby creating the second structured data set of mapped data. This data is then stored to the second database structure 39 as mapped source data, preferably including the source currency data, to form the data pool 20. Data pool 20 is stored in the data store 8. It is from this data pool 20 that mapped data can be extracted from the data store 8, and used for reporting purposes.

At least a part of the above may be related to PCT Patent Publication Numbers WO2016/000037 and WO2016/015107, both in the name of the Applicant, and which are incorporated herein by reference.

In more detail, a first organisation may record at least one transaction as a first source data set, which may have a first source currency associated therewith, and a second organisation may record at least one transaction as a second source data set, which may have a second source currency associated therewith. The first and second organisations may be mutually exclusive or may be associated, for example the first and second organisations may be subsidiaries or sisters of a parent organisation (not shown). Further, first and second source data sets may be independent, or mutually exclusive of one another, for example, a first source data set may be a financial data set and the second data set may be a non-financial data set.

An organisation may be, for example: a business; an organisation; an establishment; a business; an organisation; or any other trading operation that may have financial or non-financial data. It will be appreciated that the system may generate a report based on one or more organisations and is not limited to a first and a second organisation.

The first and second source data sets may be uploaded automatically to the system 11, or may be required to be manually uploaded to the system 11, a cloud or other storage medium associated with the system. The system 11 may also be configured to extract source data from an organisation only once a level of management has approved the data. Preferably, the uploaded source data may contain at least one of a discrete marker or identification marker such that it may be associated with the organisation from which it was received or extracted. It will be appreciated that after each stage of mapping, the system may perform an integrity check or reference check to confirm successful mapping of data to ensure that stored source data or stored map data is correctly stored. Further, an organisation using the system may also perform an audit or other check to ensure that uploaded source data is accurate.

In one embodiment, the system 11 may require that mapped data or source data 28 be verified before allowing a report to be generated. If mapped data or source data 28 cannot be verified, the system 11 may reject the data such that it cannot be included into a report until it is verified. Optionally, the system 11 may produce a stamped unverifiable report which cannot be unstamped unless the data is verified. Unverified source data 28 may be assigned a marker which requires a particular level of management or authorised person to allow the source data to be used in a report.

Source data 28 may be stored by the system in a source format and subsequently mapped, augmented or modified, based on one or more predetermined or dynamic factors. The mapped data may then be stored in a mapping database. In one embodiment, data is only stored by the system after being mapped such that an organisation may restrict data sets from being uploaded. Optionally, predetermined rules may be triggered such that particular rules cannot be applied to the source data or the first stage mapped data.

Storing the source data in a format that is not augmented or factored before being uploaded to the system may allow storage of unmodified source data, such that an organisation may retain a backup record of transactions or data, either financial or non-financial. Other data sets may optionally be uploaded to the system which may relate to organisation standards, accounting practices or preferred business practices.

At least a portion of the source data received by the system may be used to generate a report. Data may be extracted from the system based on user preference and information which is desired to be reported. For example, if an organisation has a number of subsidiaries which have made transactions in multiple jurisdictions, a user may isolate transactions or data between a preselected number of countries or only display data which is relevant to a particular jurisdiction, for example, all transactions and/or balances made in Australia by each organisation. Any data uploaded to the system may be modified or augmented such that it may be expressed in at least one of a chart or an alphanumeric representation, or used for calculating outputs for a report.

Source data may be analysed and/or modified by the system 11 such that only relevant data is extracted for generating a report. The system 11 may be adapted to determine missing data sets or determine data sets which may correspond, or overlap or represent related data and generate a report based on extracted data sets.

In at least one embodiment, the data uploaded to the system may be encrypted. Standard cryptographic algorithms may be used to provide a hash of the source data 28 or the mapped source data which may be readily understood by the system to generate a report. For example, uploaded data may be hashed by a SHA-2 cryptographic hash function or any other suitable encryption function. This may provide additional security for a business to upload source data to the system.

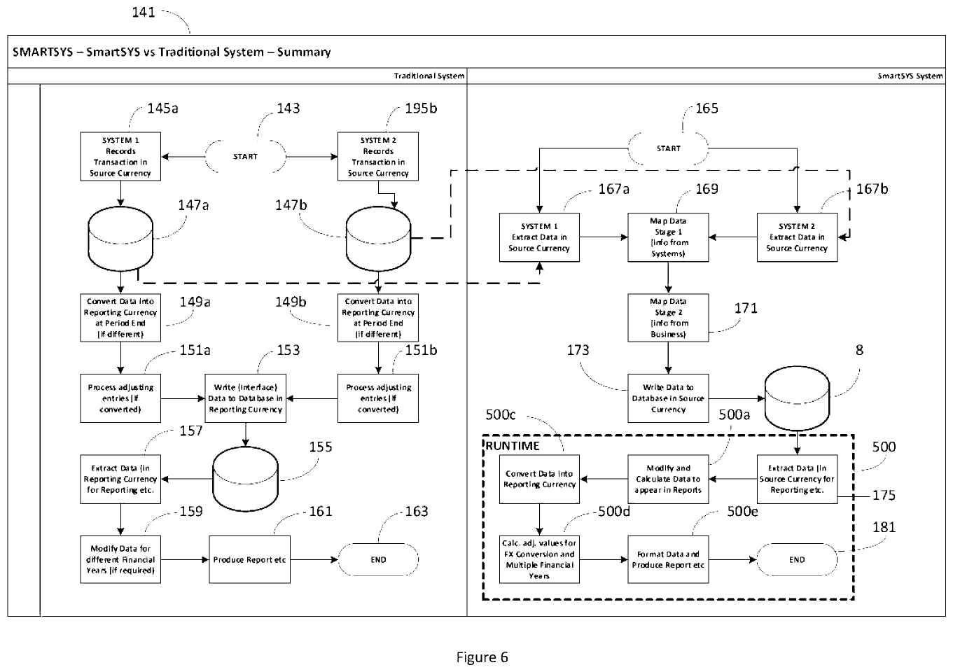

Referring to FIG. 6, there is illustrated a similar flowchart to that depicted in FIG. 5. However, in this case, the figure depicts a further feature of one embodiment of the system that enables a user to effect a runtime mode. In runtime mode 175, mapped data from data pool 20 can be extracted from the data store 8, and modified and calculated to appear as a specified output, converting the data into the reporting currency, calculating adjusting values for foreign exchange conversion and multiple financial years before formatting the data to finally produce the specified output to end the process.

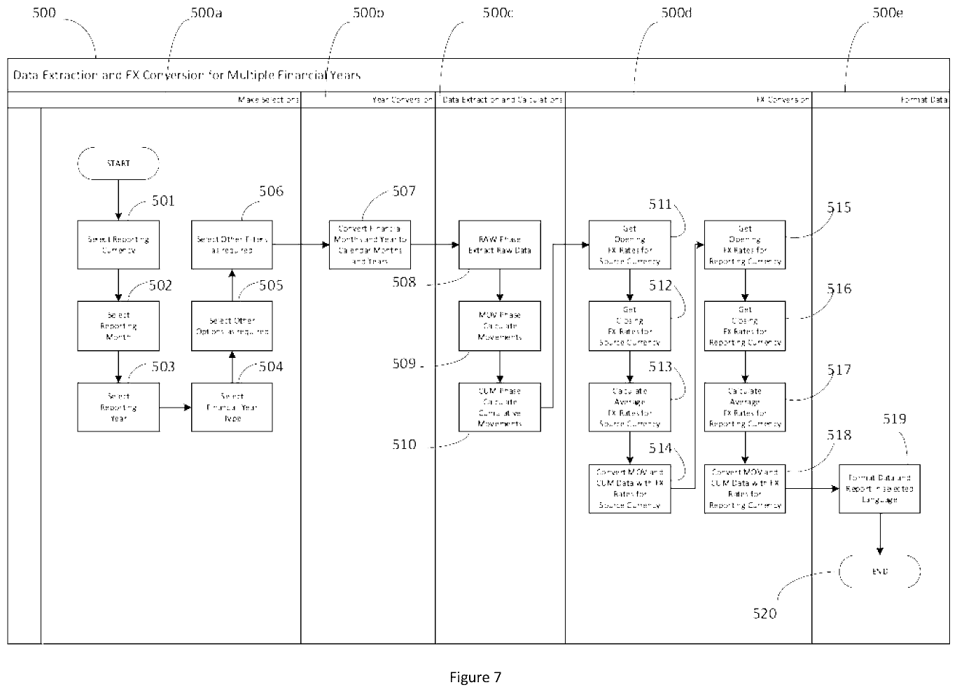

In one embodiment, runtime mode 175 (this is also referenced as 500 in FIG. 7) is used for generating a report with the system 11 using an executable runtime code which may generate a report with an improved efficiency. The system 11 may execute a runtime code which may generate a report based on the data stored in at least one of a cloud, a server or any other suitable storage medium. The runtime code of the system may allow a report to be generated more efficiently and may allow a user to convert or manipulate data, for example convert a currency based on historical or current foreign exchange data. It will be appreciated that the historical foreign exchange data may be averaged or manipulated to produce a consistent reporting method which may allow at least one time period, but preferably a plurality of time periods, which may allow more accurate foreign exchange rates to be used in the conversion of data when generating a report.

The data may be manipulated or augmented by the system during runtime code 500 based on at least one of a user preference, a predefined data set or any other predetermined factor. As illustrated, when a user of the system executes a runtime code 500 to generate a report, the system extracts mapped source data from the storage means 8, in which the mapped source data preferably comprises at least one source currency data set. In at least one embodiment, a report may include an analysis and/or a diagnostic. Referring in particular to FIGS. 5 and 6, at the selection step 500A a user may be directed to select a reporting currency 501 which is preferably a fiat currency, for example Japanese Yen or United States Dollars, which may be the same as or different to the source currency data extracted. Alternatively, the system may assign a fixed currency for a default report, such as reporting in United States Dollars (USD). After a reporting currency has been selected, a user may request a bid for currency conversion or foreign exchange (FX) rate. The currency conversion or exchange rate may be obtained from a source which is independent from the system or may be associated with the system, such as an online based foreign exchange (FX) for example XE™ or FOREX. Other FX providers or sources may also be used by the system 11.

In one embodiment, the system may have a preselected list of FX providers which a user may select. Alternatively, a custom field may be used to allow a user to input a preferred FX provider, currency conversion source or request a midpoint FX rate, a bid FX rate or an ask FX rate. A selected foreign exchange may be based on a predetermined period, such as a live rate, a day, a week, a month, a year, or any other predetermined date range or predefined period, for example a financial year. Historical FX data may be stored by the system such that a report may be generated at a later time and associated with the stored historical data. The FX rate may be an average rate, a bid rate or an ask rate, which may preferably be a year or month average rate.

In at least one embodiment, the opening FX rate relates to the closing FX rate of a respective previous time period. More particularly, the closing FX rate of the previous time period may be the same FX rate as the opening rate for the respective next period.

The use of averaged FX data provides a significant advantage as this may allow a more accurate report to be generated for a predetermined period of time, relative to existing systems. Optionally, the system may allow a user to generate a day, week, month average or year to date average such that reports generated over a period of more than a day may display a more accurate financial account.

A user may then select a reporting year 503 and optionally a reporting month 502. The selected year may be assigned a year type by the user 504, such as a client, calendar, entity, reporting year, a financial year (or particular financial year regime), a business year or any other predetermined type. A year type may be a number or code assigned from 1 (one) to 12 (twelve), in which the number corresponds to a calendar month of the year, for example, 1 (one)=January to December, 3 (three)=March to February, 7 (seven)=July to June, etc. It will be appreciated that other naming conventions may be used by the system.

After a year type has been selected, the system 11 may determine whether a predetermined specific year type has been selected which may open or restrict filtering options for a user to generate a report. Other options may also be selected by the user 505, such as a reporting language. Preferably, the system 11 may generate a report in at least one language which will comply with reporting regulations. Preferably, the system may generate a report in at least one language selected from a database of multiple languages stored by the server of the system or accessible by the system.

Other filters may also be applied by a user 506 to generate a report based on at least one predetermined factor. Restricting filters may be based on the authority level of the user as well as the year type selected. For example, a user may have the option to generate a management report based on the user authorisation level if the system determines that that user's level meets a predetermined threshold. More particularly, a manager may generate a detailed report, within their authority, which may view any level of detail, while an entry level employee or other authorised user may be restricted to a lower level view of the report (which does not contain less information than a detailed report viewable by the manager).

After a user has made year and month selections, the system may then identify the financial year type and convert the financial year to a calendar year 507. Converting a year to a financial year may be used to assign a predetermined variable or factor to a data set, or another financial or non-financial variable. Optionally, a thirteenth month may be used when calculating or modifying data, such that a statutory report, such as an annual report or a compliance report, may be more efficiently generated for reporting purposes. For example, a thirteenth month may allow the system to appropriately adjust entries to convert management account information or data into statutory accounts or compliance accounts.

In yet a further embodiment, the system is adapted to generate a report with multiple financial years. If multiple financial years are determined by the system, the system may apply an associated factor or modification based on the financial year. Further, the system may also apply more than one factor or manipulate the raw data (also referred to as ‘source data’) based on entity or organisational information, which may or may not have the same financial year. For example, if the date range of 1 Jan. 2010 to 31 Dec. 2010 is selected for generating a report for USA and Australia, the system may identify a single financial year for the USA (January to December=financial year) and two financial years for Australia (July to June=financial year), and apply a predetermined factor, modification or rule to the raw data sets. This may result in at least 3 different sets of rules being applied to the raw data (one for the USA and two for Australia).

After converting to a calendar year, the raw data stored by or associated with the system may be extracted 508 and is preferably relevant to the time period and the authorisation of the user. This may allow raw data, to be extracted more efficiently and ensure that only data within a prescribed time period is assessed by the system for generating a report which may reduce the time it takes to generate a report. The raw data is preferably associated with a day and month date and additional identifiers may be associated with the raw data, such as a time of day a transaction has occurred or a geographical location in which that transaction occurred.

Using the relevant raw data, the system calculates movements from the raw data 509. The movements of the raw data can, for example, be a monthly calculation of the overall equity of an organisation. The cumulative movements of the data 510 are calculated with respect to the total revenue and the total expenditure, which identifies the equity of a company, or movements of a company being calculated. Calculating the cumulative movements can provide a means for verifying transactions or balances. Further, cumulative movements per month can be used to compare month gains and losses regardless of financial year periods. Records for cumulative movements may be associated with a financial system or a non-financial system and may be used to track assets, such as stock, shares, trust funds, bonds or any other asset, employees, or other business drivers.

For example, the cumulative movement can be calculated for an organisation with both an Australian segment and a US segment. As the Australian and the US financial years begin 6 months relatively apart, there are a number of difficulties when comparing profits and losses for the segments for a given financial year. The system addresses this difficulty by generating the cumulative movements per month for each segment, which can be compared by the system irrespective of the financial year. This then allows profits and losses to be calculated for multiple segments and displayed for a predetermined range of dates.

Cumulative movement for a segment may be calculated adding the equity of a segment to the result of the total revenue and the total expenditure. For example, the equity for the Australian segment at the start of a month is $150,000 AUD, the total revenue for a month is $850,000 AUD, and total expenditure is $400,000 AUD. Therefore, the cumulative movement for the month is equity+revenue−expenditure=cumulative movement ($1,000,000 (revenue+equity)−$400,000=$600,000 equity).

The equity can then be converted by the system into a foreign currency for comparison between the US and the Australian segments. This may include data from multiple financial years or jurisdictions to be easily viewable in a single currency format. If a report is desired to be generated for reporting US dollars (USD) with transactions in Australia and the USA, the totals before conversions should appear as USD and AUD, respectively. Therefore, as the report will require conversion into USD and the transactions from the USA are already in the relevant country, the system will only apply a relevant conversion rate or factor to the AUD currency such that a final total is generated which is represented in a single currency. It at least one embodiment, the mapped source data includes a source currency.

Generating cumulative movements can provide a checking feature which allows an account of movements to be calculated. Current systems and methods generate a year to date (YTD) account history which can be open to exploitation. The YTD method accounts for all revenue up to the current month, which may allow a user to alter a previous entry or accidently enter an incorrect accounting entry, which generates a permanent difference which cannot be easily reconciled. In contrast, the present system calculates movements which may backtrack to check for discrepancies within accounts or balances. This allows a user to compare a cumulative movement with accounting balance data such that an exact month can be determined which contains an error or discrepancy. This can provide a more secure account report generation method and may reduce embezzlement or fraudulent accounting from occurring.

To determine the relevant exchange rates for the system the opening FX rates 511 and the closing FX rates 512 are extracted from historical or current FX rates, such that an average FX rate may be determined by the system 513. The opening and closing FX rates may be the opening and closing rates for the source currency country, for example, if the source currency is in USD, the opening and closing FX times may relate to the United States opening and closing FX times (e.g. 8 am EST to 3 pm EST). It will be appreciated that other predetermined FX jurisdictions may be selected to obtain at least one relevant FX rate.

The opening FX rates for a source currency may be obtained from a FX market or FX provider (XE™ or FOREX) which the organisation had used for a previous transaction. It will be appreciated that the system may be adapted to obtain multiple FX rates for the source data from different FX providers. Optionally, mapped source data may be assigned a preferred FX provider or historical FX rate.

In one embodiment, the FX opening rates are the same as the previous period FX closing rates. The FX opening rates and closing rates may be obtained from the same FX markets such that an average between the opening and the closing FX rates may be obtained. It will be appreciated that the opening and closing rates may relate to a particular time or time zone, for example, the opening FX rate may be associated with the USA FX market or the London FX market.

The movement and the cumulative movement source currency data may then be converted or modified by the calculated FX rates 514. The opening FX rates for the reporting currency may then be calculated 515 and as well as the closing FX rates for the reporting currency 516. The opening and closing FX rates obtained for the reporting currency may then be used to calculate at least one average FX rate for which may be used to generate a report. It will be appreciated that a plurality of opening and closing FX rates may be obtained by the system, such that predetermined time periods each have an average FX rate which may be subsequently averaged again.

For example, if the reporting period is over a month, the system 11 may generate an average FX rate for each of the business days independently and average the calculated daily business FX rates to produce a more accurate representation of the true FX rate. Currently systems may only take a single opening FX rate and a single closing FX rate to calculate an average FX rate, which will likely contain a number of significant calculation inaccuracies and result in distorted reporting due to the assumptions in the average FX rate calculation. Inaccuracies generally occur as organisations may use different assumptions to generate a management report or accounting report. This may lead to noncompliance or deviations with international reporting requirements or jurisdictional requirements, and may further provide inaccuracy if different segments/divisions/subsidiaries of an organisation use different assumptions.

At least one of the movement and the cumulative movement data for the reporting currency can then be generated by the system 518 which formulates a data set to generate a report. The report may comprise at least one FX data value which has been converted using the FX conversion system of the present invention.

After the movement and cumulative movement data has been calculated and converted with the reporting currency FX rates, the system may format the data and generate a report in at least one predetermined language or dialect. The report is preferably generated in a standard format, such that the data fields may be updated with a dictionary that comprises common reporting terms across multiple languages. However, it will be appreciated that dictionary databases with more extensive vocabulary may be used by the system to generate a more comprehensive report or a report in more than one language.

A report may be generated by extracting the source data in the cloud or server and then modifying and/or augmenting the source data based on at least one predetermined rule or equation to generate modified data. The modified data may then be represented as alpha-numerical data, such as a currency value, which may be displayed to a user of the system.

The system may be adapted to import at least one foreign exchange conversion (FX conversion) value. This FX conversion value may be a historical conversion value for a predetermined period of time such that a report may be generated with a daily, weekly, monthly and/or yearly FX conversion rate which may improve the overall accuracy of a report. It will be appreciated that other predetermined time periods or FX conversions may be used to generate a report.

Preferably, the system may generate a report in real time, such that current organisational accounts with respect to financial and/or non-financial data may be generated. Generating a real-time report may allow an organisation to gain an up to date perspective of current operations. This may provide a substantial improvement to an organisation as it may detect more early if sections of the organisation are, for example, over-producing, under-producing, overstaffed, understaffed, meeting performance goals or other operational or financial outcomes for an organisation. The term “real-time” may mean instantaneous, near instantaneous, within second(s), within minute(s), within hour(s), or on the same day.

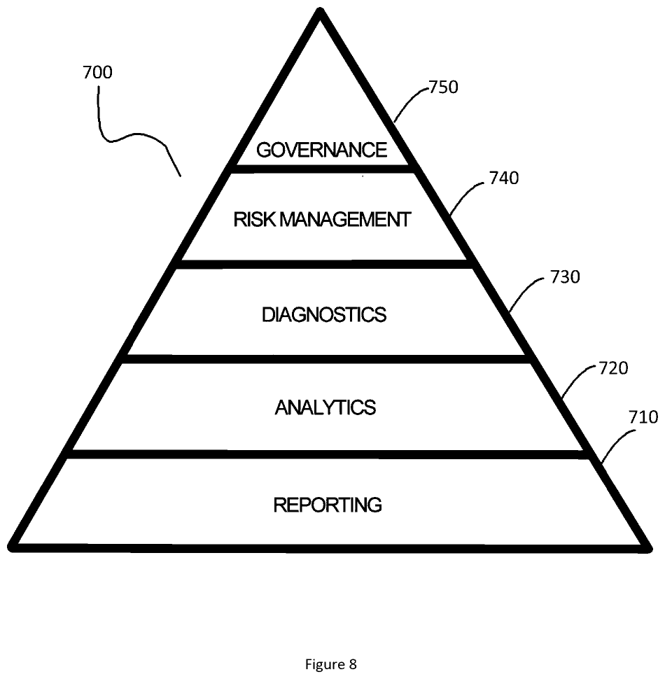

Referring to FIG. 8, there is illustrated a hierarchy 700 for generating a report according to one embodiment of the invention. The broad aspect of the system 11 generally has a reporting level 710 which may provide a significant amount of filtered or consolidated information. The information contained in the reporting level may then be analysed more narrowly by, for example, applying a filter to view a particular segment of an organisation.

The analysis or analytics level 720 may compare information within the reporting with a number of predetermined rules or requirements. A diagnostic level 730 may then be generated based on the information in the reporting such that if the report has generated an issue, for example, there has been a breach of a predetermined requirement, that issue will progress to a risk management level 740.

The risk management level 740 may then assess the importance of the issue and flag or notify the issue to a governing body at a governing level 750 within the organisation to address any issues which are of sufficient importance. It will be appreciated that while an issue may be uncovered, the issue may not progress to a higher level if a higher level deems the issue to be unimportant or to have an insignificant impact on the organisation. Further, the system may assign an importance level to any issued uncovered, such that a higher importance issue is more likely to be addressed by a user before relatively lesser important issues, if any.

In a particular example, the system may generate a report with a current asset value of $1,000 and a current liability value of $2,000 at the reporting level. The analysis level may then analyse this information to determine a liquidity value (liquidity value=current assets/current liabilities) which would result in 0.5 ($1,000/$2,000). The diagnostics level may then compare the liquidity value to rules or requirements that are preferable and/or to statutory requirements. An acceptable liquidity value for a company should be greater than unity (i.e. 1 (one)) and more preferably around 1.5. Therefore, as the report has generated a liquidity value of 0.5, the diagnostics will issue an alert or notification for risk management. The risk management level 740 may assess the issue and determine whether the issue should progress to the governance level 750. The governance level 750 may act to address an issue and may provide new rules, importance thresholds or other markers to at least one of the reporting level 710, analytics level 720, diagnostics level 730 and/or risk management level 740.

In at least one embodiment, the system may store previously generated reports such that a user may have a record of generated reports to reduce runtime period waiting. This may save a significant amount of time and money for an organisation with increased efficiency. Further, reports saved by the system 11 may reduce the runtime period of the system if a report is to be generated with at least one of a different foreign currency, a different language or a different reporting format. The reporting format may be any predetermined format and may align with an organisational standard or a regulatory standard.

In another embodiment, the system may generate a report for a meeting and generate a regional report for a number of predetermined countries, such as the countries attending a meeting, based on at least a local currency or geographical region. This may allow a user to easily generate a regional report across multiple currencies for easier understanding, while simultaneously maintaining a consistent representation of data for all recipients of a report.

For example, an audio and/or visual meeting may be held between Japan, Australia and France via videoconference or other audiovisual electronic mechanism. A user may generate a single report that can be displayed in real-time in multiple languages and/or currencies. Further a common language may be chosen or selected by a user display across multiple jurisdictions and display data in a common jurisdictional language, such as French for France (with currency in Euros), Japanese for Japan (with currency in Yen) and English for Australia (currency in Australian Dollars).

The system may be configured to generate a regional report by either pre-assigning a preferred language or currency. Alternatively, the system may detect a regional specific data set to generate a report. For example, if the original data is representative of Japanese Yen, the system may assign an output report in Japanese language with Yen as the currency, or the system may be configured to detect a preassigned or preferred language and currency format for a report for a meeting.

It will be appreciated that other detection methods may be used to determine the audience or viewer of a report, such that the system may display a regional report to a user. Optionally, the system 11 may optionally output a report in a saveable format, such as a word document, a DocX, PDF or any other readable or printable medium.

In a further embodiment, the system may be a subscription based system such that a user may be required to pay a subscription fee for a predetermined time period for access to the system. A subscription may have a number of tiers based on the type of organisation applying to use the system, the size of the organisation applying to use the system, or any other predetermined factor.

In yet another one embodiment, the system generates a report in which the system comprises:

a storage medium with at least one database, the at least one database having a first source data set associated with a first segment of an organisation and a second source data set associated with a second segment of the organisation, at least one of the first source data set or the second source data set having at least one associated source currency data set;

a foreign currency exchange rate data set or real-time access to a foreign currency exchange rate data set;

wherein the system references the foreign currency exchange rate data set to calculate an average foreign exchange rate based on at least one set of temporally dependent rates, and converts the source currency data set by the average foreign exchange rate to a respective foreign currency for generating a report in real-time.

In one embodiment, the set of temporally dependent rates is a set of daily rates. Optionally, a set of daily rates can be business day rates which exclude weekends and public holidays. Alternatively, the daily rates can reflect the days in which a business is operational and excludes any closed days.

It will be appreciated that an average foreign exchange rate may be calculated for a predetermined time, in which the predetermined time may be separated into a plurality of discrete time intervals such that multiple average foreign exchange rates are calculated over the predetermined time for converting the source currency. Multiple average foreign exchange rates may be averaged such that the average of the multiple average foreign exchange rates can be used to convert the source currency data set.

At least one data base includes a first stage mapping database and a second stage mapping database. At least one of the first source data set and the second source data set may be mapped by a first stage mapping process and assigned to the first stage mapping database and stored as first stage mapping data, and the first stage mapping data may subsequently be mapped by a second stage mapping process and assigned to the second stage mapping database and stored as mapped source data.

The system may be adapted to apply at least one cryptographic function, such as a hash function, to the mapped source data. A report may be generated in a foreign language selected from the at least one database. The at least database may comprise a dictionary which includes foreign language conversion terms. The system may further generate a report including multiple financial years and can be converted to be shown in a predetermined language or predetermined currency. The system may automatically determine a currency and a language to generate a report.

A report may be generated by the system by executing a runtime code, in which the runtime code may extract data to compile into a report. The compiled data, which is mapped source data, may include financial and non-financial data and be converted by the runtime into at least one language and/or convert accounting data into a predetermined currency using foreign exchange rates. The report generated by the system may be stored by a user on the system or on a personal device, for later viewing or for organisational archiving. This may increase an organisational productivity. Storing a report may allow the system to convert the report in real time to multiple users in at least one further language and/or at least one further currency.

In yet a further embodiment, the system for generating a report comprises a storage medium with an associated database. The associated database may comprise a plurality of data sets associated with at least one organisation and the plurality of data sets preferably includes at least one associated source currency data set. The average FX rate can be calculated by the system based on a monthly average exchange rate. The FX rate may be calculated from the number of days in a given month and more preferably, the days are business days which exclude weekends.

For example, a quarterly FX rate can be generated from three consecutive months of data. In this example, a first month has an exchange rate of 0.98, a second month has an exchange rate of 0.97 and a third month has an exchange rate of 0.96, which results in an average year to date average of 0.97. The opening and the closing rates may be used to generate the monthly average FX rate. A closing can be generated from the assets and the liabilities, and the opening rate may relate the equity within a company. The average rate can be generated from the revenue and expenditure, which is the median of the opening and closing rates. The FX rate can be generated in real-time by the system. In this example, the current period opening rate is equal to the prior period closing rate.

A system for generating a financial report, the system comprising; a storage medium with an associated database; the associated database comprising a plurality of data sets from at least one organisations; the plurality of data sets comprising at least one currency and at least one language; and wherein the system translates a report in real-time to a predetermined user specified currency and language which is adapted to be displayed to a user.

Preferably, the system displays a corresponding report to a second user simultaneously in at least one of a different language or different currency. Optionally, the system comprises at least two databases including a mapping database and a dictionary database, such that the dictionary database is used to generate a report in a predetermined language, and the mapping data base may store organisational mapped source data.

It will be appreciated that the data manipulated, augmented or converted by the system does not alter or interact with the original source or raw data, and the original organisation data may be stored independently of the system in an organisational preferred storage device. Preferably, the source data of an organisation may be used to verify data before or after generating a report if desired by a user. This may improve report generation reliability to ensure that data has not been corrupted or misassigned.

Having a first stage mapping and a second stage mapping may allow a set of data to be stored by the system in a first database and a second database. This may allow faster processing for a particular report. For example, the database may be used to generate a statutory report or may be used to generate a quarterly report or annual report. Reports may be for internal purposes or may be publicly disclosed documents, such as an annual report for shareholders. Having a first and second database structure may reduce the runtime of the system to generate a report.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

It is to be noted that, throughout the description and claims of this specification, the word “comprise” and variations of the word, such as “comprising” and “comprises”, is not intended to exclude other variants or additional components, integers or steps. Modifications and improvements to the invention will be readily apparent to those skilled in the art. Such modifications and improvements are intended to be within the scope of this invention.

1. A system for generating a financial report reflecting financial information in a reporting currency, the system comprising:
a storage medium with at least one database;
the at least one database comprising a first source data set associated with a first segment of an organisation and at least a second source data set associated with a second segment of an organisation;
the first source data set representing a first financial value relevant to the financial information and the at least a second source data set representing at least a second financial value relevant to the financial information, each financial value having at least one associated source currency which is the same or different as between the first financial value, the second financial value and the reporting currency; and
a foreign currency exchange rate data set, or access to a foreign currency exchange rate data set, that has foreign currency data relevant to at least the source currency for each of the first financial value and the at least a second financial value and to the reporting currency,
wherein the system manipulates, augments and/or converts the first source data set and the at least a second source data set to determine the financial information, and uses at least one foreign exchange rate from a set of foreign exchange rates extracted from the foreign currency exchange rate data set and converts the financial information by the at least one foreign exchange rate to the reporting currency for generating the financial report.

2. The system as claimed in claim 1, wherein financial report is generated in real-time.

3. The system as claimed in claim 1, wherein the average foreign exchange rate is calculated for a predetermined time.

4. The system as claimed in claim 3, wherein the predetermined time is separated into a plurality of discrete time intervals such that multiple average foreign exchange rates are calculated over the predetermined time for converting the source currency.

5. The system as claimed in claim 4, wherein the foreign currency exchange rate data set includes one or more of the following foreign exchange rates: an opening exchange rate, being the exchange rate at which the discrete time interval began, a closing exchange rate, being the exchange rate at which the discrete time interval closed, and an average exchange rate, being an average of the exchange rates throughout the discrete time interval.

6. The system as claimed in claim 1, wherein the at least one database includes a first stage mapping database and a second stage mapping database.

7. The system as claimed in claim 6, wherein the manipulation, augmentation and/or conversion of the first source data set and the second source data set is carried out in association with at least one of the first source data set and the at least second source data set being mapped by a first stage mapping process and assigned to the first stage mapping database and stored as first stage mapping data.

8. The system as claimed in claim 7, wherein the first stage mapping data is further mapped by a second stage mapping process and assigned to the second stage mapping database and stored as mapped source data.

9. The system as claimed in claim 8, wherein at least one cryptographic function is applied to the mapped source data.

10. The system as claimed in claim 1, wherein the report is generated in an alternate language selected from the at least one database.

11. The system as claimed in claim 1, wherein the system is adapted to generate the report taking account of different financial year regimes applying to different source data sets.

12. The system as claimed in claim 11, wherein, in taking account of the different financial year regimes, the system adjusts the different financial year regime data so as to provide consolidated financial information.

13. The system as claimed in claim 1, wherein the system is adapted to automatically determine a currency and a language to generate a report.

14. The system as claimed in claim 1, wherein executing a runtime code generates the report.

15. The system as claimed in claim 1, wherein the generated report is stored by the system.

16. The system as claimed in claim 1, wherein a report is displayed to different users in different languages.

17. The system as claimed in claim 1, wherein the second segment of an organisation is a another entity.

18. A system for generating a financial report, the system comprising
a storage medium with an associated database;
the associated database comprising a plurality of data sets associated with at least one organisation;
the plurality of data sets including at least one source currency data set associated therewith; and
wherein the system calculates an average foreign exchange rate, with respect to at least one opening foreign exchange rate and at least one corresponding closing exchange rate, such that source currency data set can be converted by the average foreign exchange rate to represent a respective foreign currency for generating the report in real-time.

19. A system for generating a report, the system comprising;
a storage medium with an associated database, the database stores a plurality of data sets;
the plurality of data sets comprising at least one currency and at least one language; and
wherein when a user selects a predetermined output language and a predetermined output currency, the system executes a runtime that generates an output report in real-time, in which the at least one currency is output in the predetermined output currency and the at least one language is output in the predetermined language.

20. The system as claimed in claim 19, wherein the system displays an output report to a second user via a user display device in at least one of the group consisting of: the at least one language; the output language; the at least one currency; and the output currency

21. The system as claimed in claim 20, wherein the system comprises at least one database selected from a mapping database and a dictionary database.

22. The system as claimed in claim 21, wherein the dictionary database is used to generate a report in a predetermined language.
